(19) United States
(12) Patent Application Publication
(10) Pub. No.: US 2014/0117193 A1
(43) Pub. Date: May 1, 2014

(54) STAND FOR A PORTABLE ELECTRONIC DEVICE

(71) Applicant: Alison Wong, Menlo Park, CA (US)

(72) Inventor: Alison Wong, Menlo Park, CA (US)

(21) Appl. No.: 14/032,691

(22) Filed: Sep. 20, 2013

Related U.S. Application Data
(60) Provisional application No. 61/719,841, filed on Oct. 29, 2012.

(51) Int. Cl. F16M 13/00

(52) U.S. Cl. CPC F16M 13/005
USPC 248/351

(57) ABSTRACT

A stand for an electronic device, such as a smart phone has an elongated shaft with a handle end and spaced apart projecting members, one of which engages a port of the electronic device. Engagement is controlled either by pivoting until a pivot stop member sets a desired angle or by interlocking or frictional engagement of a projecting member with a port. The roles of members may be reversed or only a single projecting member used in an interlock engagement with the device.

### CROSS-REFERENCE TO RELATED APPLICATION

This application claims priority under 35 U.S.C. 119(e) from prior U.S. provisional application No. 61/719,841, filed Oct. 29, 2012.

### TECHNICAL FIELD

The present invention relates to stands for portable electronic devices, and specifically a removable stand which is attachable to the device and which allows the device to be propped up at an upright angular orientation.

### BACKGROUND

Personal electronic devices have become ubiquitous, particularly smart phones and music players, together with larger tablet devices. An example of a popular current smart phone is the iPhone 5, manufactured by Apple Computer, Inc. of Cupertino, Calif. The iPhone 5 has a form factor that is generally rectangular in shape with a thickness of about 1 cm, a width of about 6 cm and a length of about 12 cm. Other smart phones, of course, have other dimensions and shapes, but a majority of today's smart phones and tablets are thin and rectangular. Current smart phones typically include a touch screen, an integral camera, and an onboard memory for retaining music files, videos, and photos for display on the screen. There is a demand for such smart phones to be within the thickness form factor mentioned above and yet remain both functional and ergonomic. These requirements conflict a bit when the user wants to support the phone angularly upright at a desired inclined angle with respect to a support surface to allow for more comfortable viewing of videos on the screen, video chatting, or taking photos with the forward facing, or back facing camera, without having to be held. Often the sleek shape and smooth materials of a smart phone make it difficult to be supported against an object, such as a book.

It is therefore an object of the present invention to provide a stand for a smart phone electronic device and similar devices.

### SUMMARY OF THE INVENTION

The above object has been satisfied with a removable stand that cooperates with a communication or electrical port of a portable electronic device of the type having at least the thickness form factor dimension of a smart phone. The stand is for positioning the device on a support surface at an inclined angle. The stand features an elongated shaft defining a longitudinal axis and having a handle at one end and a foot at a distal end projecting perpendicularly from the shaft. Adjacent to the foot, a pin projects perpendicularly from the shaft, parallel and slightly spaced from the foot and having a selected size and shape to fit within a communication port of the device, such as an earphone port. In a preferred embodiment, the pin and foot are integral with the shaft in a unitary structure. The pin has a round cross-section fitting into a round port, such as an earphone port, and pivoting therein, allowing the handle end to contact a support surface. Pivoting is stopped by the foot that projects perpendicularly from the distal end, parallel to the pin but spaced apart from the pin by a distance that allows pivoting to a desired angle until the foot interferes with further pivoting.

When pivoting is stopped, the spacing between the foot and the pin is such that the device will be angularly inclined so that the screen or the reverse side is propped up at an angle between 30 degrees and 60 degrees with the handle resting on the support surface and the shaft carrying some of the load or weight of the device from the pin and port, through the handle, to the support surface.

In other embodiments, the pin or foot may interlock with, or frictionally engage, a round or non-round communication port, such as a USB port or a combined power-data port. In this situation, one of the projecting members is not needed because the interlocking member will prevent pivoting and set the angle for the propped up device. A single pin or foot member having a shape that snugly projects into the round or non-round communication port, located at a distance from the handle along the axis of the shaft, with a tight frictional or interlocking fit, will support the propped up device. However, the length of the shaft and the position of the member on the shaft must be selected to obtain a desired angle of the propped up device. A telescoping shaft may be used to select a desired angle in this situation.

### DESCRIPTION OF THE DRAWINGS

FIG. 1 is a front view of a stand for an electronic device in accordance with the invention;

FIG. 2 is a perspective view of the stand of FIG. 1, shown supporting an exemplary smart phone at a predetermined angle with respect to a support surface;

FIG. 2A is a perspective view of a modified stand of FIG. 1;

FIG. 2B is a perspective view of the stand of FIG. 2A supporting a smart phone at a predetermined angle relative to a support surface;

FIG. 3 is a perspective view of a first alternate embodiment of the stand of FIG. 1;

FIG. 4 is a perspective view of a second alternate embodiment of the stand of FIG. 1;

FIG. 5 is a perspective view of the stand of FIG. 3, shown supporting an exemplary smart phone at a predetermined angle with respect to a support surface;

FIG. 6 is a perspective view of a third alternate embodiment of the stand of FIG. 1;

FIG. 7 is a perspective view of a fourth alternate embodiment of the stand of FIG. 1; and

FIG. 8 is a perspective view of a fifth alternate embodiment of the stand of FIG. 1.

### DETAILED DESCRIPTION

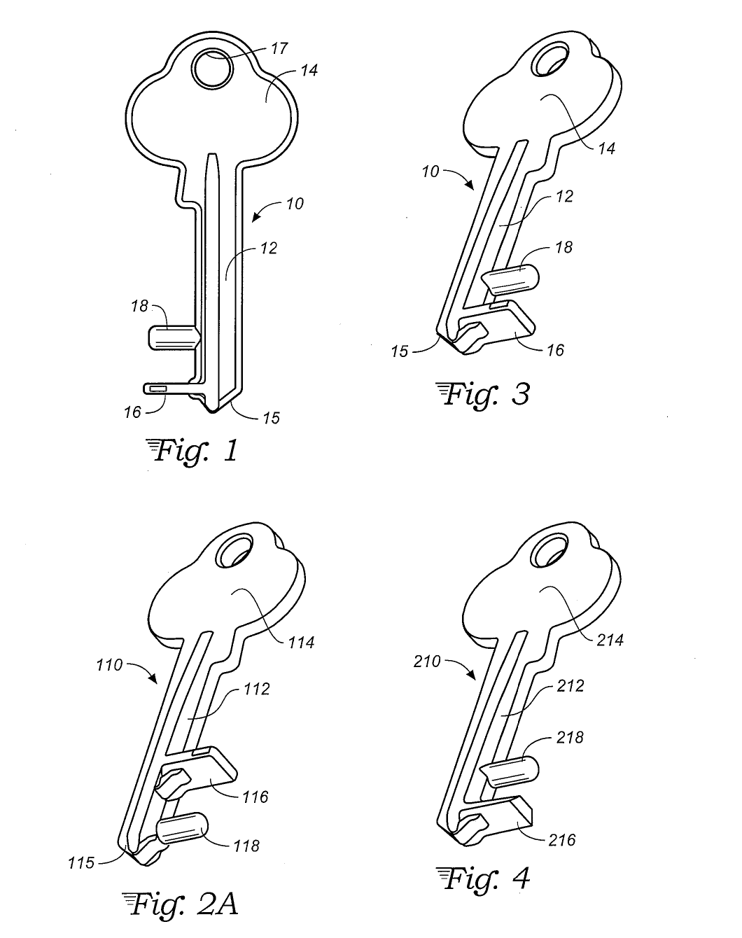

With reference to FIG. 1, a portable stand 10 is shown having an elongated shaft 12, a handle end 14, a distal end 15, and a foot 16. Foot 16 projects perpendicularly from elongated shaft 12. A pin 18 is formed adjacent to foot 16 a predetermined distance. Pin 18 is sized and shaped to selectively and snugly fit into a communication port of an electronic device, as described below. The term “communication port” is used throughout this application and includes electronic earphone jacks, USB connection ports, power connection ports, and the so-called “Lightning port” found on the iPhone 5, manufactured by Apple Computer Co., Cupertino, Calif.

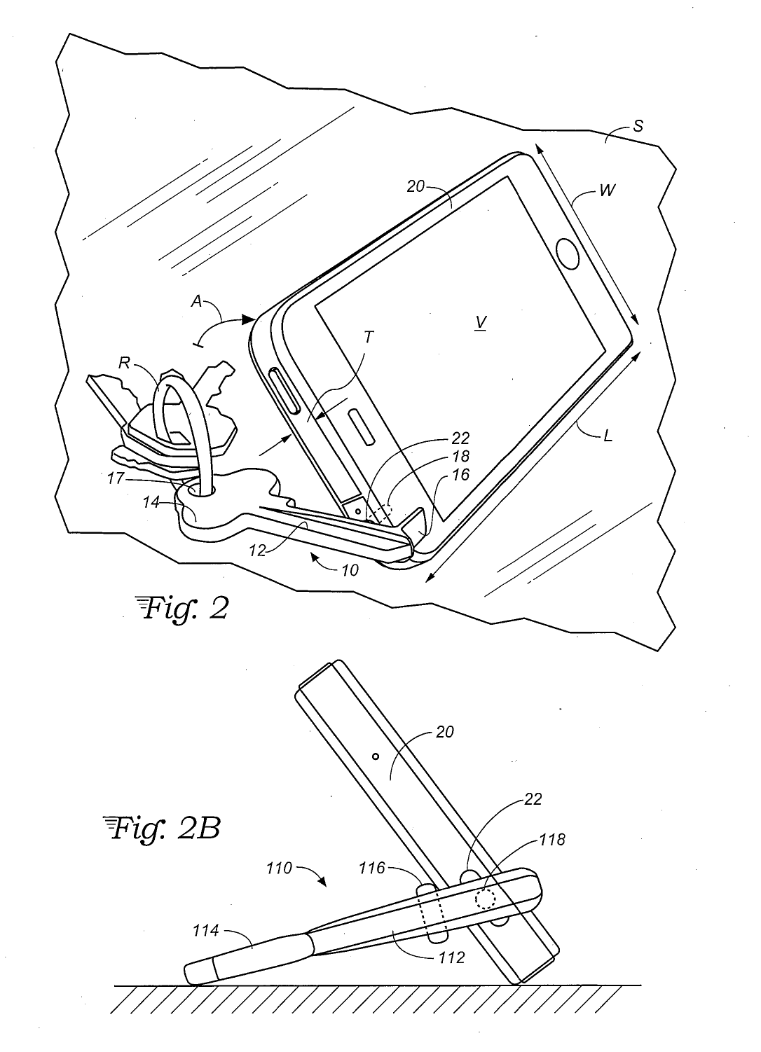

With reference to FIG. 2, an exemplary electronic device is shown to have a form factor that includes a length, L, a width, W, and a thickness, T. While dimensions of smart phones and electronics music players can vary, the thickness dimension is usually about 1 cm or less. The thickness form factor dimension is significant for this invention because communication ports are located within the thickness dimension, usually centered in the thickness dimension. This is important because the spacing between the pin member and the foot member of the stand will be on the order of the thickness dimension, perhaps slightly less.

In FIG. 2, the stand 10, is seen to have the elongated shaft 12 with an end 14 resting on the support surface, S. The pin 18, seen in dashed lines, having dimensions of a smart phone headphone jack, is inserted into an earphone port 22 within the thickness dimension of the electronic device. In this situation, the pin has a round cross section, fitting into the round earphone port in a closely fitting relationship to the extent that pivoting is allowed. The handle end 14 is placed on the support surface and pivoting is stopped by interference of the foot 16, resembling a flat blade projecting from the elongated shaft 12, stops further rotation.

In this case, the spacing of the pin 18 from the foot 16 allows the viewing screen, V, to be inclined at the angle, A, which is between 30 and 60 degrees, although other angles could be selected for different needs. Foot 16 could also be behind pin 18 closer to handle 14 so that it rests upon the opposite side of the device, as illustrated in FIGS. 2A and 2B.

In FIGS. 2A and 2B, the foot 116 of stand 110 is closer to handle 114, while pin 118 is adapted to pivotally or frictionally engage the earphone port of the electronic device. In FIG. 2B, pin 118, projecting from shaft 112, fits into earphone port 22 of device 20 while the foot 116 interferes with pivoting beyond a desired angle. Shaft 112 and handle 114 correspond to shaft 12 and handle 14 of FIG. 1.

Returning to FIG. 2, the handle 14 may have a hole 17 so that the handle may be joined to a key set and ring, R. Preferably, the handle and shaft have dimensions approximating a common key. When kept on a key ring, other keys on the key ring can help adjust the propped up angle of the device by being placed beneath the shaft to increase the angle of a viewing screen towards the vertical. The length of shaft 12 approximates the length of a typical key, i.e., 5-6 centimeters, although this dimension is not critical.

With reference to FIG. 3, the foot 116 projects perpendicularly from the shaft 112 at an end 115 which is opposite and distal to handle end 114. In the embodiment of FIG. 3, the foot 116 has a shape that is geometrically congruent with the shape of a power-data port found within the thickness dimension of the electronic device. The shape of foot 116 is non-round and the foot is not intended to rotate within the port but to interlock or frictionally engage the port so that the two functions of the projecting members of the stand of FIG. 1 are no longer needed. In FIG. 1, the projecting pin acts as a pivot, while the foot member 16 was a pivot stop.

FIG. 4 shows an embodiment that is similar to FIG. 3. A foot 216 has a cross sectional shape that is congruent with the shape of a USB port and fits within the USB port of an electronic device. The placement of the foot on the handle will determine the angular orientation of the device, i.e., the foot angle is selectable. In this situation the foot 216 interlocks with the USB port supporting the device, transferring a portion of the load of the device through the shaft 212 to the handle 214 that rests on a support surface. The pin 218 which projects from the shaft 212 has a minor role in supporting a portion of the load of the device but does not engage the device as in FIG. 1.

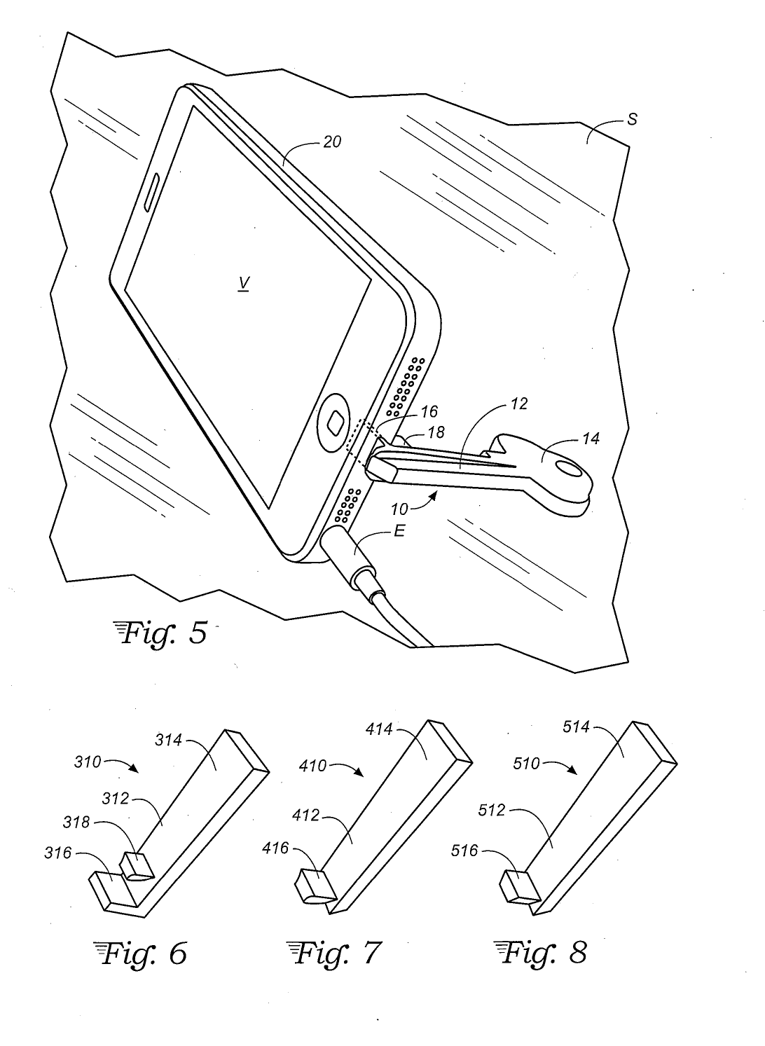

With reference to FIG. 5, the stand 110 has a rectangular, cross-sectional shaped foot 116, shown in dashed lines, extending into a power-data port for frictional or interlocking engagement. The pin 118 is seen behind the device 20 optionally providing some support. In the embodiment of FIG. 5 the earphone port is being used by the earphone jack, E, and is not involved with the stand 110. The USB foot embodiment of FIG. 4 would be used in the same way, as previously described, except that the USB foot would be inserted into a USB port and interlocked with the port as if it were a plug of an electronic cable.

In the embodiment of FIG. 6, the stand 310 has a handle 314 and a foot 316 at the end opposite the handle. An intermediate projecting member 318 has the shape of a USB port for interlocking engagement with the port. Thus, in FIG. 6 the intermediate member 318 engages the port, while the foot 316 optionally provides stabilization.

In FIG. 7, the stand 414 has the elongated shaft 412 with a single member 416 opposite the handle 414. The member 416 projects perpendicularly from the elongated shaft 412 and has the shape of a USB port for engaging the port, as well as an appropriate angle for propping a device at a desired view angle. The length of shaft 412 may be any desired length that is appropriate for the electronic device being supported. For example, tablets having screens of 6 inches to 9 inches or larger may be supported. Any of the previously described embodiments may be adapted for that purpose, providing an appropriate length is selected for the elongated shaft 412 or the corresponding shaft in other embodiments.

In FIG. 8, an embodiment similar to FIG. 7 is shown, except that the foot 516 is appropriate to a power-data port, rather than a USB port. In either situation, a communications port is selected with the foot having a cross-sectional shape that is generally congruent and fits within the selected port. In each case the foot perpendicularly projects from the shaft 512 at an end of the shaft opposite the handle 514.

Stand 10 is preferably made from a strong and durable plastic, such as polycarbonate, using an appropriate plastic injection process. A rubber or TPE overlay is preferably included using an appropriate and well known over-mold process. Pin 18 and foot 16 are preferably integrally molded to shaft 12 during the molding process. Although pin 18 is shown in the figures positioned between handle 14 and foot 16, pin 18 may also be integrally formed so that foot 16 resides between handle 14 and the pin. Regardless of their relative positioning, it is important that pin 18 and foot 16 be formed adjacent to each other, spaced apart a prescribed distance. Applicant has determined that for current iPhone 5 and iPhone 4, the distance between pin 18 and foot 16 is approximately 7 mm (measured from the center of each).

Pin 18 is preferably rod shaped to fit a standard headphone jack, and may even resemble the shape of an actual headphone jack having a diameter of about 3.5 mm and a length of about 13 mm. Foot 16 is preferably generally rectangular in cross-section, with an approximate length of 7 mm and shaped to fit a second communication port, such as the so-called “Lightning port” of the iPhone 5. Pin 18 and foot 16 are integrally formed parallel to each other, perpendicular to shaft 12 and both facing a common direction, as shown in the figures.

What is claimed is:

1. A stand for positioning a portable electronic device on a support surface, the device having at least the thickness form factor dimension of a smart phone and having an at least one port in the thickness dimension comprising:
a shaft defining a longitudinal axis with a handle at one end and a foot at an opposite distal end projecting perpendicularly from the shaft; and
a pin projecting perpendicularly from the shaft adjacent to the foot at a distance from the foot and having a pin cross section fitting into the port, wherein the spacing of the pin from the foot allows pivoting of the device about the pin until stopped by the foot such that when the handle end contacts a support surface the device is angularly inclined relative to the support surface.

2. The apparatus of claim 1 wherein the foot has a rectangular cross-sectional shape.

3. The apparatus of claim 1 wherein the handle and shaft have dimensions approximating a key.

4. The apparatus of claim 1 wherein the pin has dimensions approximating a smart phone headphone jack.

5. The apparatus of claim 1 wherein the handle, shaft and pin are integral.

6. A stand for positioning a portable electronic device on a support surface, the device having at least the thickness form factor dimension of a smart phone and having an at least one port in the thickness dimension comprising:
a shaft defining a longitudinal axis with a handle at one end and a foot at an opposite distal end projecting perpendicularly from the shaft; and
a pin projecting perpendicularly from the shaft adjacent to the foot at a distance from the foot and the pin or foot having a cross section fitting snugly within a communication port, wherein the spacing of the pin from the foot allows engagement of the device with the pin or foot such that when the handle contacts the support surface the device is angularly inclined relative to the support surface.

7. The apparatus of claim 6 wherein the pin has the cross sectional shape congruent with the cross sectional shape of a USB port.

8. The apparatus of claim 6 wherein the foot has the cross sectional shape congruent with the cross sectional shape of a USB port.

9. The apparatus of claim 6 wherein the pin has the cross sectional shape congruent with the cross sectional shape of a power-data port.

10. The apparatus of claim 6 wherein the foot has the cross sectional shape congruent with the cross sectional shape of a power-data port.

11. The apparatus of claim 6 wherein the handle and shaft have dimensions approximating a key.

12. The apparatus of claim 6 wherein the handle, shaft and pin are integral.

13. A stand for positioning a portable electronic device on a support surface, the device having at least the thickness form factor dimension of a smart phone and having an at least one round or non-round communication port in the thickness dimension comprising:
a shaft defining a longitudinal axis with a handle at one end and a foot at an opposite distal end projecting perpendicularly from the shaft, wherein the foot has a cross-sectional shape generally congruent with the shape of the communication port of said device wherein the foot fits within the port in a frictional or interlocking manner such that when the handle contacts the support surface the device is angularly inclined relative to the support surface.

14. The apparatus of claim 13 wherein the foot has the cross sectional shape congruent with the cross sectional shape of a USB port.

15. The apparatus of claim 13 wherein the foot has the cross sectional shape congruent with the cross sectional shape of a power-data port.

16. The apparatus of claim 13 wherein the handle and shaft have dimensions approximating a key.

17. The apparatus of claim 13 wherein the handle, shaft and pin are integral.
